(19) United States
(12) Patent Application Publication
(10) Pub. No.: US 2023/0112385 A1
(43) Pub. Date: Apr. 13, 2023

(54) METHOD OF OBTAINING EVENT INFORMATION, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Qi Wang, Beijing (CN); Zhifan Feng, Beijing (CN); Chunguang Chai, Beijing (CN); Yong Zhu, Beijing (CN)

(73) Assignee: BEIJING BAIDU NETCOM SCIENCE TECHNOLOGY CO., LTD., Beijing (CN)

(21) Appl. No.: 18/079,846

(22) Filed: Dec. 12, 2022

(30) Foreign Application Priority Data
Dec. 13, 2021 (CN) 202111519645.2

(51) Int. Cl. G06F 16/432; G06F 16/483

(52) U.S. Cl. CPC G06F 16/432; G06F 16/483

(57) ABSTRACT

A method of obtaining an event information, an electronic device, and a storage medium, which relate to a field of artificial intelligence, in particular to fields of knowledge graph and deep learning technologies. A specific implementation solution of the method of obtaining the event information includes: determining, according to a query information in data to be processed, a first key information describing an event; determining, according to multimedia data in the data to be processed, a second key information describing an event, wherein the multimedia data includes data obtained by querying based on the query information; and fusing the first key information and the second key information, so as to obtain an event information of a target event described by the data to be processed.

This application claims priority to Chinese Patent Application No. 202111519645.2 filed on Dec. 13, 2021, which is incorporated herein in its entirety by reference.

### TECHNICAL FIELD

The present disclosure relates to a field of artificial intelligence, in particular to fields of knowledge graph and deep learning technologies, and more specifically to a method of obtaining an event information, an electronic device, and a storage medium.

### BACKGROUND

In an era of mobile Internet and big data, multimedia data on the Internet has shown an explosive growth. As an increasingly rich information carrier, deep semantic understanding of multimedia data has become a basis of a plurality of intelligent applications, and has an important research significance and a practical application value. In a related art, it is usually difficult to perform a semantic understanding of multimedia data from a perspective of real needs of users, which may affect a proper development of intelligent applications to some extent.

### SUMMARY

The present disclosure provides a method of obtaining an event information, an electronic device, and a storage medium.

According to an aspect of the present disclosure, a method of obtaining an event information is provided, including: determining, according to a query information in data to be processed, a first key information describing an event; determining, according to multimedia data in the data to be processed, a second key information describing an event, wherein the multimedia data includes data obtained by querying based on the query information; and fusing the first key information and the second key information, so as to obtain an event information of a target event described by the data to be processed.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of obtaining the event information provided by the present disclosure.

According to another aspect of the present disclosure, a non-transitory computer-readable storage medium having computer instructions therein is provided, and the computer instructions are configured to cause a computer to implement the method of obtaining the event information provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an application scenario of a method of obtaining an event information according to embodiments of the present disclosure;

FIG. 2 shows a flowchart of a method of obtaining an event information according to embodiments of the present disclosure;

FIG. 3 shows a schematic diagram of a principle of obtaining an event information of a target event according to embodiments of the present disclosure;

FIG. 4 shows a schematic diagram of a principle of obtaining an event information according to embodiments of the present disclosure;

FIG. 5 shows a schematic diagram of a principle of determining a similarity between two events according to embodiments of the present disclosure;

FIG. 6 shows a structural block diagram of an apparatus of obtaining an event information according to embodiments of the present disclosure; and

FIG. 7 shows a structural block diagram of an electronic device for implementing a method of obtaining an event information according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The present disclosure provides a method of obtaining an event information, including a first information extraction stage, a second information extraction stage, and an event information determination stage. In the first information extraction stage, a first key information describing an event is determined according to a query information in data to be processed. In the second information extraction stage, a second key information describing an event is determined according to multimedia data in the data to be processed. The multimedia data includes data obtained by querying based on the query information. In the event information determination stage, the first key information and the second key information are fused to obtain an event information of a target event described by the data to be processed.

Technical terms involved in the present disclosure are explained as follows.

Argument: in linguistics, an argument typically refers to a nominal word in a sentence. The argument is generally a noun phrase indicating a participant of an event or action.

Argument role: a role played by a participant of an event or action in the event or action.

Thematic relation: a thematic relation refers to a semantic role of an argument, such as “agent” and “patient”. In the present disclosure, the argument in the query information or the argument in the multimedia data may be determined according to the thematic relation.

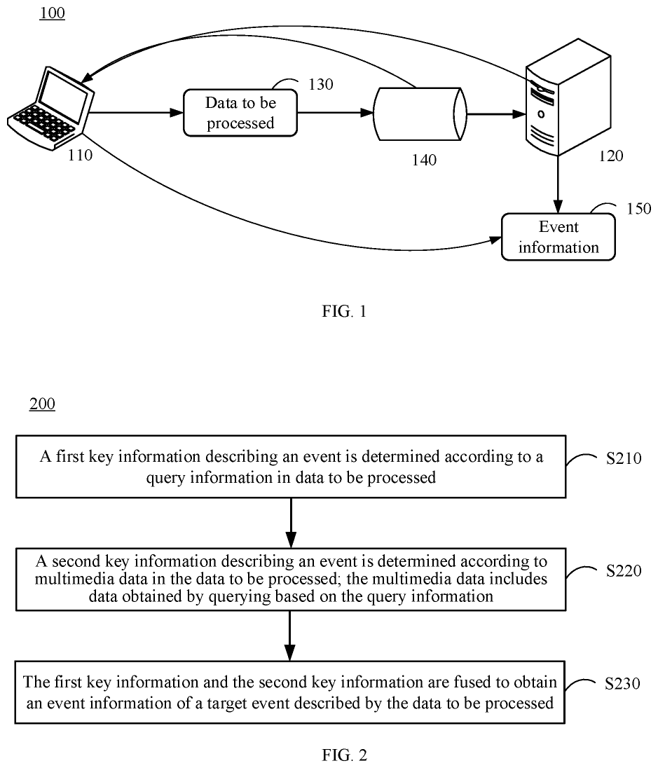

An application scenario of a method and an apparatus provided by the present disclosure will be described below with reference to FIG. 1.

FIG. 1 shows a schematic diagram of an application scenario of a method and an apparatus of obtaining an event information according to embodiments of the present disclosure.

As shown in FIG. 1, an application scenario 100 may include a terminal device 110 and a server 120. The terminal device 110 may be communicatively connected to the server 120 through a network, and the network may include a wired or wireless communication link.

The terminal device 110 may be, for example, a smart phone, a tablet computer, a portable computer, a desktop computer, or other electronic devices. The terminal device 110 may be installed with client applications such as web browser applications, video playback applications, search applications, and/or shopping applications. Data may be queried by a user through the client application installed in the terminal device 110.

The server 120 may be, for example, a server that provides various services, such as a background management server (for example only) that provides a support for an information queried by the user using the terminal device 110. The background management server may receive a query request (including a query information query) sent by the terminal device 110 in response to a user operation, and feed back a query result (such as a text list, an image list, a video list, a webpage link list and other multimedia data lists) to the terminal device 110, for the terminal device 110 to display to the user.

According to embodiments of the present disclosure, in the application scenario 100, the query information in the query request sent by the terminal device 110 and the received query result may be used as data to be processed 130, and the data to be processed 130 may be written into a database 140. In order to facilitate semantic understanding of multimedia data in the query result and extract an event information, the terminal device 110 may, for example, acquire the data to be processed 130 from the database 140 periodically or in response to a user operation, and obtain an event information 150 from the data to be processed 130. Alternatively, the server 120 may acquire the data to be processed 130 from the database 140 periodically or in response to a user operation, and obtain the event information 150 from the data to be processed 130.

When obtaining the event information 150 from the data to be processed, the terminal device 110 or the server 120 may not only identify multimedia data in the data to be processed 130, but also identify a query information in the data to be processed 130. In this way, it is possible to achieve a weak supervision on the obtaining of the event information, ensure that the event information is obtained from data describing a same event, and thus improve an accuracy of the obtained event information.

It should be noted that the method of obtaining the event information provided by the present disclosure may be performed by the terminal device 110 or the server 120. Accordingly, the apparatus of obtaining the event information provided by the present disclosure may be provided in the terminal device 110 or the server 120.

It should be understood that a number and a type of terminal device, server and database in FIG. 1 are merely schematic. According to implementation needs, any number and type of terminal devices, servers and databases may be provided.

A method of obtaining an event information provided by the present disclosure will be described in detail below through FIG. 2 to FIG. 5.

FIG. 2 shows a flowchart of a method of obtaining an event information according to embodiments of the present disclosure.

As shown in FIG. 2, a method 200 of obtaining an event information in such embodiments may include operation S210 to operation S230.

In operation S210, a first key information describing an event is determined according to a query information in data to be processed.

According to embodiments of the present disclosure, the query information may be a query text input by a user. For example, if the user wants to know how to make candied haws, the user may enter “method of making candied haws” in a search box displayed by a terminal device, and the query information is a query text “method of making candied haws”. It may be understood that if an image is input by the user to query multimedia data, the query information may also be the image input by the user.

According to such embodiments, the query information may be processed to obtain the first key information describing the event. For example, if the query information is a query text, such embodiments may be implemented to process the query information by using a text processing method. The text processing method may include, for example, a keyword extraction method, a subject matter extraction method, an entity recognition method, and/or a text classification method. A result obtained by the text processing method may be used as the first key information. If the query information is an image, such embodiments may be implemented to process the query information by using an image processing method. The image processing method may include, for example, a target detection method and/or an image classification method. In such embodiments, a result obtained by the image processing method may be used as the first key information.

In operation S220, a second key information describing an event is determined according to multimedia data in the data to be processed. The multimedia data includes data obtained by querying based on the query information.

According to embodiments of the present disclosure, the multimedia data in the data to be processed may be, for example, multimedia data fed back by a server in response to a query request. The multimedia data may be an image, a video, and/or a text. Such embodiments may be implemented to perform a semantic understanding on the multimedia data by using a processing method matched with the multimedia data, so as to obtain the second key information. For example, if the multimedia data is an image, the matched processing method may include the aforementioned target detection method and/or image classification method. If the multimedia data is a video, a semantic understanding may be performed on a video frame in the video by using the aforementioned processing method matched with images, and a result of the semantic understanding of a plurality of video frames may be used as the second key information. If the multimedia data is a text, a semantic understanding may be performed on the text by using the aforementioned keyword extraction method, subject matter extraction method, entity recognition method and/or text classification method.

According to embodiments of the present disclosure, in a case that the multimedia data fed back by the server in response to the query request contains a plurality of data, the multimedia data in the data to be processed may be, for example, a predetermined number of top-ranked data among the plurality of data. Considering that the top-ranked data among the data obtained by querying is generally data more in line with a user need or data matched with the query request more closely, in such embodiments, by determining the second key information according to the top-ranked data, it may be ensured to some extent that the second key information describes the event accurately, and that the event described by the determined second key information is a same event as the event described by the first key information.

According to embodiments of the present disclosure, in a case that the multimedia data fed back by the server in response to the query request contains a plurality of data, the multimedia data in the data to be processed may be, for example, accessed data among the plurality of data. The accessed data refers to data selected by the user after a query result is displayed on the terminal device. The accessed data may reflect a real need of the user to a certain extent. Therefore, the second key information determined according to the accessed data is an information that describes the event more accurately.

According to embodiments of the present disclosure, in a case that the multimedia data fed back by the server in response to the query request contains a plurality of data, the multimedia data in the data to be processed may be, for example, data describing a same subject matter event as the query information among the plurality of data. For example, for each data in the multimedia data, each data may be classified using the aforementioned processing method matched with the multimedia data, so as to determine a subject matter category of each data. Similarly, a subject matter category of the query information may be determined, and the subject matter category of the query information may be added to the first key information. Then, the second key information describing the event may be determined according to the multimedia data having the same subject matter category as the query information in the data to be processed. In this way, it may be ensured to some extent that the event described by the determined second key information is a same event as the event described by the first key information, and the accuracy of the determined second key information may be improved.

In operation S230, the first key information and the second key information are fused to obtain an event information of a target event described by the data to be processed.

According to embodiments of the present disclosure, a union of the first key information and the second key information may be determined as the event information of the target event described by the data to be processed. The target event is the event corresponding to the query data in the data to be processed.

According to embodiments of the present disclosure, the event information may include, for example, an event name, an event category, an event keyword, or the like. For example, the event name may be a key information containing nouns and verbs in the first key information and the second key information, or the event name may be a key information obtained using the aforementioned subject matter extraction method. The event category may be a key information describing any one of a plurality of predetermined categories in the first key information and the second key information.

When both the first key information and the second key information include a key information describing a predetermined category, the key information describing the predetermined category in the first key information may be used as the event category, because the data obtained by querying based on the query information may be irrelevant to the query information, and the query information may better reflect a user need.

The method of obtaining the event information in embodiments of the present disclosure not only includes determining a key information from the multimedia data, but also includes determining a key information from the query information. Therefore, the determined event information may better meet a real need of the user, so that an accuracy of a downstream application such as an information recommendation or an event recognition may be improved, and a user experience of the downstream application may be improved.

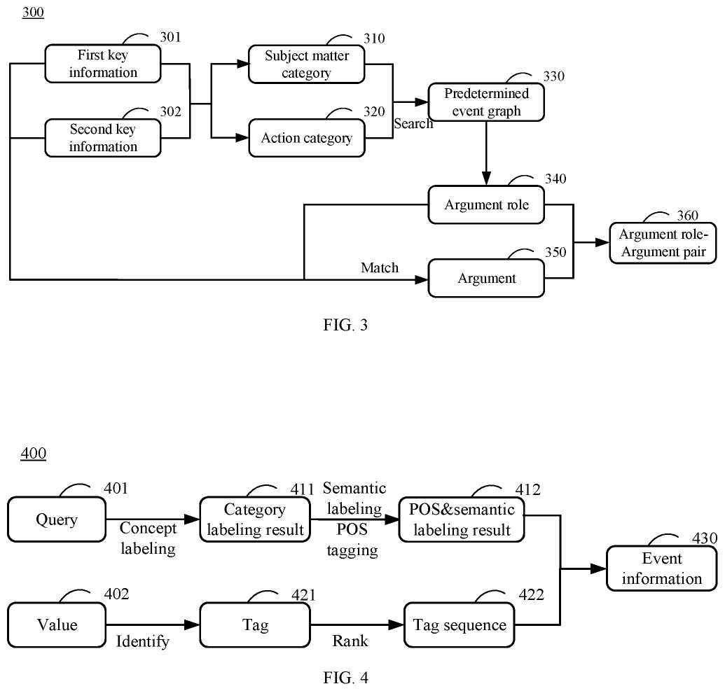

FIG. 3 shows a schematic diagram of a principle of obtaining an event information of a target event according to embodiments of the present disclosure.

According to embodiments of the present disclosure, when obtaining the event information, for example, event information of different categories of events may be constrained and defined in advance. For example, it is possible to preset a mapping relationship between an event category and an argument role described by the event information.

According to such embodiments, when determining the event information of the target event, a category of the target event may be determined firstly according to the first key information and the second key information. An argument role having a mapping relationship with the target event may be determined according to the mapping relationship between the category and the argument role. Then, an argument may be assigned to the argument role from the first key information and the second key information.

For example, for an event of a food production category, the argument roles having a mapping relationship may include a dish name, a cooking style, an ingredient, a taste, a dish category, and so on.

According to embodiments of the present disclosure, in general, each event belongs to a subject matter, and events under a subject matter include a plurality of types of events with different actions. Therefore, in such embodiments, it is needed to determine a subject matter category of the target event and an action category of the target event when determining the category of the target event.

In an embodiment 300 shown in FIG. 3, after a first key information 301 and a second key information 302 are obtained, a subject matter category 310 of the target event and an action category 320 of the target event may be determined according to the first key information 301 and the second key information 302. After the subject matter category 310 and the action category 320 are obtained, at least one argument role matched with the target event in a predetermined event graph may be determined.

For example, in the embodiment 300, a predetermined event graph 330 may be maintained, which may indicate a mapping relationship between a subject matter category of an event, an action category of an event, and an argument role matched with an event. In such embodiments, it is possible to search the predetermined event graph according to the subject matter category and the action category, and find at least one argument role 340 matched with the target event from the predetermined event graph.

For example, the first key information and the second key information may contain a subject matter category and a keyword representing an action. When the query information is a text, the subject matter category of the query information may be determined using a text classification method, and may be added to the first key information. The subject matter category of the query information may be any one of a plurality of predetermined subject matter categories. Similarly, the subject matter category of the multimedia data may be determined using a classification method matched with the multimedia data, and may be added to the second key information. In such embodiments, when the subject matter category in the first key information is the same as the subject matter category in the second key information, the same subject matter category may be used as the subject matter category of the data to be processed. When the subject matter category in the first key information is different from the subject matter category in the second key information, the subject matter category in the first key information may be used as the subject matter category of the data to be processed. As described above, if the multimedia data has been selected according to the subject matter category when determining the second key information, the subject matter category in the first key information may be the same as the subject matter category in the second key information.

For example, the plurality of predetermined subject matter categories may be set according to actual needs. For example, the plurality of predetermined subject matter categories may include 36 categories, such as food, medical treatment, culture, military affairs, science and technology, and so on.

For example, in the embodiment 300, an action category library may be maintained. For each subject matter category in a plurality of predetermined subject matter categories, the action category library may include at least one action category belonging to the subject matter category. For example, the action category library may include more than 1500 action categories. The action categories belonging to the food category may include a food production/teaching category, a mukbang category, and so on. The action categories belonging to the culture category may include a dance category, a music teaching category, a music vocal category, and so on. In the embodiment 300, a word describing an action in the first key information and the second key information may be aligned with the action category library. Specifically, the word describing the action in the first key information may be replaced by an action category name that describes the same action as the word describing the action in the key information. When the first key information contains a plurality of words describing actions, such embodiments may be implemented to select a core word from the plurality of words describing actions according to importance of the words describing actions in the query information, and align the core word with the action category library.

For example, if the word describing the action in the first key information and the word describing the action in the second key information describe different actions, the action category may be determined according to the word describing the action in the first key information. If the word describing the action in the first key information and the word describing the action in the second key information describe a same action, the word describing the action in the first key information and the word describing the action in the second key information may be fused to determine the action category. For example, if the word describing the action in the first key information is “launch” and the word describing the action in the second key information is “launch aircraft”, the action category may be determined as “launch aircraft”. The action category may also be determined by aligning with the action category library as described above.

When the at least one argument role 340 is obtained, an argument 350 matched with the at least one argument role may be determined according to the first key information and the second key information, so as to obtain an argument role-argument pair 360. The argument role-argument pair 360 may be used as the event information of the target event. Alternatively, both the argument role-argument pair 360 and the aforementioned action category may be used as the event information.

For example, the first key information and the second key information may be keywords obtained through semantic labeling, and such embodiments may be implemented to match a semantic labeling result of the keyword with the argument role. The argument role may be assigned with the argument according to a matching result. Alternatively, such embodiments may be implemented to query a pre-built knowledge graph according to each information in the first key information and the second key information, so as to obtain a key information matched with each argument role, and the key information may be used as the argument for the argument role. The knowledge graph may be built according to a large number of argument role-argument pairs. Nodes in the knowledge graph may include argument role nodes and argument nodes, and there is a connecting edge between a node of an argument role and a node of an argument, which form an argument role-argument pair.

According to such embodiments, by defining the argument role for the determined event information, it is possible to avoid a problem of a deviation from an actual application scenario caused by an overly detailed mining of the event information. Accordingly, the event information determined by using the method of such embodiments may be more accurately applied to a downstream task in a multimedia data understanding scenario. The downstream task may include, for example, a multimedia data recommendation task, an illegal behavior identification task, or the like.

FIG. 4 shows a schematic diagram of a principle of obtaining an event information according to embodiments of the present disclosure.

In an embodiment 400, a query information including a query text is illustrated by way of example in describing the principle of obtaining the event information.

As shown in FIG. 4, in the embodiment 400, a category labeling may be performed on a query text 401 as a query, so as to obtain a category of each word in the query text, and a corresponding relationship between each word and the category may be used as a category labeling result 411. For example, a category labeling may be performed on the query text by using a concept labeling method. The concept labeling method may be used to classify each word obtained by tokenization, determine a concept each word belongs to, and mark the concept as the category of the word. The concept each word belongs to may be any concept in a concept database maintained in an existing encyclopedia database.

In the embodiment 400, after the category of each word is obtained, Part-Of-Speech tagging and Semantic Role Labeling may be further performed on the word in the query text, so as to obtain a labeling result. The labeling result may be specially a part-of-speech & semantic labeling result 412. An event name, a word describing an action and a keyword in the query text may be recognized according to a result of Part-Of-Speech tagging and Semantic Role Labeling. In such embodiment, a set of recognized words may be used as the first key information.

Part-Of-Speech tagging (POS tagging) is also known as grammatical tagging or word-category disambiguation, which is a text data processing technology in corpus linguistics for marking a part-of-speech of a word in a corpus according to meanings and context. Part-Of-Speech tagging may be performed by using a part-of-speech tagging algorithm, which may include, for example, Hidden Markov Model (HMM), Conditional random fields (CRFs), or the like.

Semantic Role Labeling (SRL) is a shallow semantic analysis technology for analyzing a predicate-argument structure of a sentence by using a sentence as a unit, without an in-depth analysis of a semantic information contained in the sentence. Specifically, a task of Semantic Role Labeling is to study a relationship between each component of a sentence and a predicate of the sentence with the predicate as a center, and describe the relationship by using a semantic role. The semantic role may include, for example, agent, subject matter, trigger, or other roles.

In an embodiment, after the word describing the action is obtained, the word describing the action may be associated with the aforementioned action category in the action category library by a method similar to Entity Linking, and the associated action category may be used as the word describing the action in the first key information.

In an embodiment, after the category of each word in the query text is obtained, it may be determined firstly whether the query text contains a word of a scene category. If not, it may be determined that no event is described by the query text, and the data to be processed may be discarded directly. If the query text contains a word of the scene category, Part-Of-Speech tagging and Semantic Role Labeling may be performed on the query text. In this way, processing of event-irrelevant data may be avoided to some extent, and a waste of computing resources may be reduced.

In the embodiment 400, a tag identification may be performed on multimedia data 402 as Value. Specifically, the multimedia data may be identified by using a data identification method matched with the multimedia data 402, so as to obtain at least one tag 421 describing the multimedia data 402. Then, the tags may be ranked to obtain a tag sequence 422. In such embodiments, the tag sequence may be used as the second key information.

In an embodiment, the multimedia data 402 may include, for example, data in at least two modalities. For example, if the multimedia data 402 is a video, the multimedia data 402 may include at least two selected from: data in text modality, data in audio modality, or data in image modality. The data in text modality may include, for example, a title of the video, a caption of the video, or the like. The data in image modality may include each video frame of the video, or a key frame of the video. The data in audio modality may include an audio corresponding to the video. In such embodiments, the data in each modality may be identified by using a data identification method matched with each modality, so as to obtain at least one tag 421.

For example, the identification methods adopted may include an action recognition method, a scene recognition method, a text semantic understanding method, a Mel spectrum extraction method, or the like. The identification methods may further include, for example, a classification method. It may be understood that the above-mentioned identification methods are merely used as examples to facilitate understanding of the present disclosure, and the present disclosure is not limited thereto. According to such embodiments, the second key information is determined by identifying data in at least two modalities, so that richer key information may be determined.

In such embodiments, after at least one tag is obtained by identifying the data in each modality, an operation such as a de-duplication may be performed on the tags obtained by identifying the data in at least two modalities. Remaining tags obtained after the de-duplication and other operations may be used as all tags, and all the tags may be ranked use a Rank model, so as to obtain the tag sequence 422.

After the first key information and the second key information are obtained, an event information 430 of a target event may be determined by using the aforementioned methods. For example, the event information may include the action category, the event name and the keyword in addition to the argument role-argument pair. The event name may be determined according to the core word describing the action in the first key information and the second key information and a syntactic dependency relationship associated with the core word in the data to be processed. For example, the event name may be obtained by combining the core word and a subject associated with the core word in the query information according to a word order. In such embodiments, a key information obtained by using a subject matter extraction method may also be used as the event name. For example, a key information other than the word describing the action, the subject matter category, the argument and the event name may be used as the keyword.

For example, in an embodiment, the determined event name may be “making braised pork in soy sauce”, the subject matter category is “food”, the action category is “food production/teaching”, the keywords may include “home cooking” and “dish name”, and the argument role-argument pair includes: dish name-braised pork in soy sauce, cooking style-braised in soy sauce, main ingredients-streaky pork, taste-salty and sweet, dish category-hot dishes, and so on.

In an embodiment, considering that a query result obtained according to one query information generally includes a plurality of data, the aforementioned multimedia data may include a plurality of data. In such embodiments, when determining the second key information, it is possible to obtain a set of key information according to each of the plurality of data, thereby obtaining a plurality of sets of key information. Then, the second key information may be obtained by fusing the plurality of sets of key information. Fusing the plurality of sets of key information may include, for example, determining a union of information in the plurality of sets of key information, and using the obtained union as the second key information.

It may be understood that the plurality of data included in the multimedia data may be the aforementioned remaining data obtained by selecting according to the subject matter category. In such embodiments, the second key information is obtained by fusing the key information obtained from a plurality of data, so that an integrity of the obtained second key information and an integrity of the determined event information may be improved.

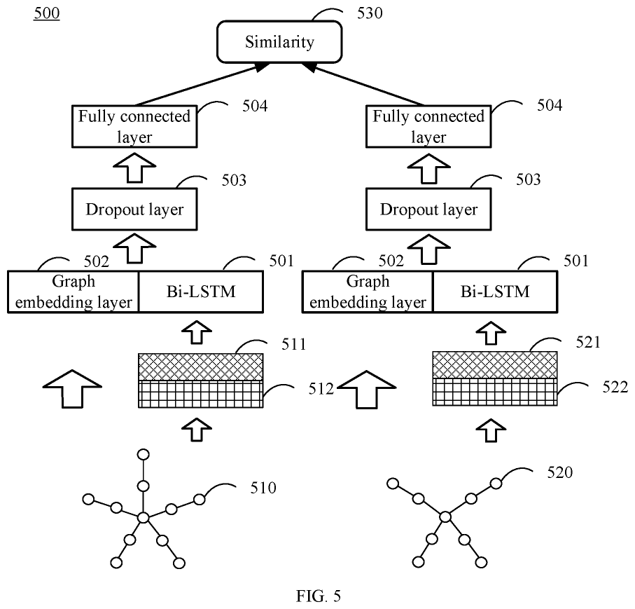

FIG. 5 shows a schematic diagram of a principle of determining a similarity between two events according to embodiments of the present disclosure.

According to embodiments of the present disclosure, after a plurality of data to be processed is processed by the aforementioned methods, event information of a plurality of events may be obtained. In such embodiments, after the event information of the plurality of events is obtained, a similarity between the plurality of events may be calculated, and it may be determined, according to the calculated similarity, whether the plurality of events include at least two events that have different event information but are essentially the same event. If so, the event information of the at least two events that are the same event may be fused. In this way, the integrity and rationality of the maintained and obtained event information may be improved, so as to avoid a problem that two sets of event information for the same event are maintained in the event database because different event information is obtained when different query information is used to query the same event. Through the methods of such embodiments, an accuracy of a downstream application may be improved.

In an embodiment 500 shown in FIG. 5, a knowledge graph for each event in a plurality of events may be determined according to the event information of each event in the plurality of events. For example, a knowledge graph 510 and a knowledge graph 520 may be obtained respectively for any two events in the plurality of events. Then, a similarity between the two events may be determined according to the two knowledge graphs for the two events. For n events, n(n−1)/2 similarities may be obtained, for example. Finally, it may be determined that two events in the plurality of events having a similarity greater than a similarity threshold are the same event.

In an embodiment, the event name of each event may be used as a central node of the knowledge graph, the argument role in the argument role-argument pair of each event may be used as a first layer node connected to the central node, and the argument in the argument role-argument pair may be used as a second layer node connected to the argument role, so as to build the knowledge graph. A connection relationship between the second layer node and the first layer node may be determined according to the corresponding relationship between the argument role and the argument.

For example, when determining the similarity between any two events, an event feature of each event may be determined firstly according to the knowledge graph, and a similarity between two event features may be determined as the similarity between the two events. For example, in the embodiment 500, the knowledge graph may be encoded by using a graph embedding algorithm, so as to obtain the event feature.

In an embodiment, in addition to encoding the knowledge graph using the graph embedding algorithm, the event information may also be encoded using a text encoding method. The two features obtained by encoding may be fused to obtain the event feature of each event. The feature obtained by encoding the knowledge graph may indicate an association between the event information, and the feature obtained by encoding the event information may indicate a semantic feature of the event information. The fusion of the two parts of features may improve an expression ability of the obtained event feature and help improve the accuracy of the calculated similarity. After the respective event features of the two events are obtained, the similarity between the two event features obtained may be determined, and the similarity may be used as the similarity between the two events.

For example, in the embodiment 500, for any two events, the knowledge graph 510 and the knowledge graph 520 may be encoded by using a graph embedding layer 502. Besides, a word embedding representation may be performed on the event information of the two events. For example, for a first event in any two events, a plurality of event information may be determined as a word sequence, and a word vector sequence 511 corresponding to the word sequence may be obtained by an embedding method such as Word2Vec. Similarly, for the second event in any two events, a word vector sequence 521 may be obtained. Then, the word vector sequence 511 and the word vector sequence 521 may be encoded using a recurrent neural network 501. In an embodiment, the plurality of event information may be divided into single characters to obtain a character sequence of the plurality of event information. Then, a character vector sequence 512 and a character vector sequence 522 corresponding to the character sequence may be obtained by using an embedding method such as Word2Vec. Accordingly, in such embodiments, the word vector sequence 511 and the character vector sequence 512 may be concatenated and input into the recurrent neural network 501, and the word vector sequence 521 and the character vector sequence 522 may be concatenated and input into the recurrent neural network 501. By encoding the event information by considering both word sequences and character sequences, the accuracy of features obtained by encoding may be improved. The recurrent neural network 501 may be, for example, a bidirectional Long Short-Term Memory network (Bi-LSTM), which is not limited in the present disclosure.

In an embodiment, after the feature encoded by the graph embedding layer 502 and the feature encoded by the recurrent neural network 501 are concatenated, for example, the concatenated feature may be processed using a Dropout layer 503, so as to avoid over fitting during a feature extraction. In an embodiment, the concatenated feature may be processed using a fully connected layer 504, so as to improve a non-linear expression ability of the encoded features. Alternatively, the concatenated feature may be processed firstly using the Dropout layer 503, then a feature output by the Dropout layer 503 may be processed using the fully connected layer 504, and a feature output by the fully connected layer 504 may be used as the event feature.

In an embodiment, a similarity 530 between two event features may be expressed by a cosine similarity, a Pearson correlation coefficient, a Jaccard similarity coefficient, or the like.

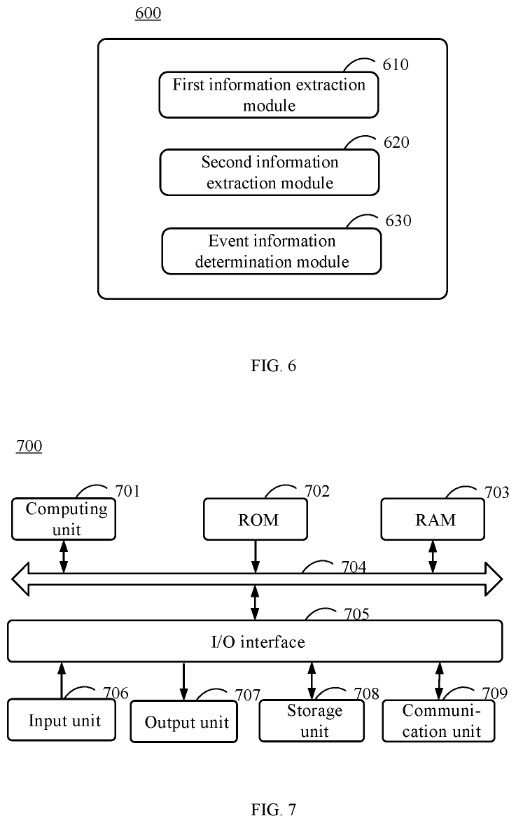

Based on the method of obtaining the event information provided by the present disclosure, the present disclosure further provides an apparatus of obtaining an event information, which will be described below in detail with reference to FIG. 6.

FIG. 6 shows a structural block diagram of an apparatus of obtaining an event information according to embodiments of the present disclosure.

As shown in FIG. 6, an apparatus 600 of obtaining an event information in such embodiments may include a first information extraction module 610, a second information extraction module 620, and an event information determination module 630.

The first information extraction module 610 may be used to determine, according to a query information in data to be processed, a first key information describing an event. In an embodiment, the first information extraction module 610 may be used to perform operation S210 described above, which will not be repeated here.

The second information extraction module 620 may be used to determine, according to multimedia data in the data to be processed, a second key information describing an event. The multimedia data includes data obtained by querying based on the query information. In an embodiment, the second information extraction module 620 may be used to perform operation S220 described above, which will not be repeated here.

The event information determination module 630 may be used to fuse the first key information and the second key information, so as to obtain an event information of a target event described by the data to be processed. In an embodiment, the event information determination module 630 may be used to perform operation S230 described above, which will not be repeated here.

According to embodiments of the present disclosure, the event information determination module 630 may include a first category determination sub-module, an argument role determination sub-module, and an argument determination sub-module. The first category determination sub-module may be used to determine a subject matter category of the target event and an action category of the target event according to the first key information and the second key information. The argument role determination sub-module may be used to determine, according to the subject matter category and the action category, at least one argument role matched with the target event in a predetermined event graph. The argument determination sub-module may be used to determine, according to the first key information and the second key information, an argument matched with the at least one argument role. The predetermined event graph indicates a mapping relationship between the subject matter category of the event, the action category of the event, and the argument role matched with the event.

According to embodiments of the present disclosure, the query information includes a query text. The first information extraction module 610 may include a second category determination sub-module, a labeling sub-module, and an information determination sub-module. The second category determination sub-module may be used to perform a category labeling on a word in the query text, so as to obtain a category of each word in the query text. The labeling sub-module may be used to perform, in response to the query text containing a word of a scene category, Part-Of-Speech tagging and Semantic Role Labeling on a word in the query text, so as to obtain a labeling result. The information determination sub-module may be used to determine, according to the labeling result, the first key information describing the event.

According to embodiments of the present disclosure, the multimedia data includes data in at least two modalities. The second information extraction module 620 may include a tag obtaining sub-module and a tag ranking sub-module. The tag obtaining sub-module may be used to identify, for data in each modality of the data in the at least two modalities, the data in each modality by using a data identification method matched with the modality, so as to obtain at least one tag. The tag ranking sub-module may be used to rank each tag obtained by identifying the data in the at least two modalities, so as to obtain a tag sequence as the second key information.

According to embodiments of the present disclosure, the multimedia data includes a plurality of data. The second information extraction module 620 may include an information extraction sub-module and an information fusion sub-module. The information extraction sub-module may be used to determine, according to each data in the plurality of data, a set of key information describing the event, so as to obtain a plurality of sets of key information. The information fusion sub-module may be used to fuse the plurality of sets of key information to obtain the second key information.

According to embodiments of the present disclosure, the apparatus 600 of obtaining the event information may further include a graph determination module, a similarity determination module, and a same-event determination module. The graph determination module may be used to determine, for the obtained event information of a plurality of events, a knowledge graph for each event in the plurality of events, according to the event information of each event in the plurality of events. The similarity determination module may be used to determine a similarity between two events in the plurality of events according to two knowledge graphs for the two events in the plurality of events. The same-event determination module may be used to determine two events in the plurality of events having a similarity greater than a similarity threshold as a same event.

According to embodiments of the present disclosure, the similarity determination module may include a first encoding sub-module, a second encoding sub-module, a feature fusion sub-module, and a similarity determination sub-module. The first encoding sub-module may be used to encode, for each event in the two events, the knowledge graph for each event to obtain a first encoded feature. The second encoding sub-module may be used to encode the event information of each event to obtain a second encoded feature. The feature fusion sub-module may be used to fuse the first encoded feature and the second encoded feature to obtain an event feature of each event. The similarity determination sub-module may be used to determine a similarity between two event features of the two events, so as obtain the similarity between the two events.

According to embodiments of the present disclosure, the multimedia data is accessed data in a plurality of data obtained by querying based on the query information.

It should be noted that in the technical solution of the present disclosure, an acquisition, a collection, a storage, a use, a processing, a transmission, a provision, a disclosure, and an application of user personal information involved comply with provisions of relevant laws and regulations, take essential confidentiality measures, and do not violate public order and good custom. In the technical solution of the present disclosure, authorization or consent is obtained from the user before the user's personal information is obtained or collected.

According to embodiments of the present disclosure, the present disclosure further provides an electronic device, a readable storage medium, and a computer program product.

FIG. 7 shows a schematic block diagram of an example electronic device 700 suitable for implementing the method of obtaining the event information according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the electronic device 700 to exchange information/data with other devices through a computer network such as Internet and/or various telecommunication networks.

The computing unit 701 may be various general-purpose and/or dedicated processing assemblies having processing and computing capabilities. Some examples of the computing units 701 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 701 executes various methods and steps described above, such as the method of obtaining the event information. For example, in some embodiments, the method of obtaining the event information may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the method of obtaining the event information described above. Alternatively, in other embodiments, the computing unit 701 may be configured to perform the method of obtaining the event information by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in an existing physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of obtaining an event information, the method comprising:
determining, according to a query information in data to be processed, a first key information describing an event;
determining, according to multimedia data in the data to be processed, a second key information describing an event, wherein the multimedia data comprises data obtained by querying based on the query information; and
fusing the first key information and the second key information, so as to obtain an event information of a target event described by the data to be processed.

2. The method according to claim 1, wherein the fusing the first key information and the second key information, so as to obtain an event information of a target event described by the data to be processed comprises:
determining a subject matter category of the target event and an action category of the target event according to the first key information and the second key information;
determining, according to the subject matter category and the action category, at least one argument role matched with the target event in a predetermined event graph; and
determining, according to the first key information and the second key information, an argument matched with the at least one argument role,
wherein the predetermined event graph indicates a mapping relationship between the subject matter category of the event, the action category of the event, and the argument role matched with the event.

3. The method according to claim 1, wherein the query information comprises a query text; and
wherein the determining, according to a query information in data to be processed, a first key information describing an event comprises:
performing a category labeling on a word in the query text, so as to obtain a category of each word in the query text;
performing, in response to the query text containing a word of a scene category, Part-Of-Speech tagging and Semantic Role Labeling on a word in the query text, so as to obtain a labeling result; and
determining, according to the labeling result, the first key information describing the event.

4. The method according to claim 1, wherein the multimedia data comprises data in at least two modalities; and
wherein the determining, according to multimedia data in the data to be processed, a second key information describing an event comprises:
identifying, for data in each modality of the data in the at least two modalities, the data in each modality by using a data identification method matched with the modality, so as to obtain at least one tag; and
ranking each tag obtained by identifying the data in the at least two modalities, so as to obtain a tag sequence as the second key information.

5. The method according to claim 1, wherein the multimedia data comprises a plurality of data; and
wherein the determining, according to multimedia data in the data to be processed, a second key information describing an event comprises:
determining, according to each data in the plurality of data, a set of key information describing the event, so as to obtain a plurality of sets of key information; and
fusing the plurality of sets of key information to obtain the second key information.

6. The method according to claim 1, further comprising:
determining, for the obtained event information of a plurality of events, a knowledge graph for each event in the plurality of events, according to the event information of each event in the plurality of events;
determining a similarity between two events in the plurality of events according to two knowledge graphs for the two events in the plurality of events; and
determining two events in the plurality of events having a similarity greater than a similarity threshold as a same event.

7. The method according to claim 6, wherein the determining a similarity between two events in the plurality of events according to two knowledge graphs for the two events in the plurality of events comprises:
encoding, for each event in the two events, the knowledge graph for each event to obtain a first encoded feature;
encoding the event information of each event to obtain a second encoded feature;
fusing the first encoded feature and the second encoded feature to obtain an event feature of each event; and
determining a similarity between two event features of the two events, so as obtain the similarity between the two events.

8. The method according to claim 1, wherein the multimedia data is accessed data in a plurality of data obtained by querying based on the query information.

9. An electronic device, comprising:
at least one processor; and
a memory communicatively connected to the at least one processor, wherein the memory stores instructions executable by the at least one processor, the instructions, when executed by the at least one processor, are configured to cause the at least one processor to at least:
determine, according to a query information in data to be processed, a first key information describing an event;
determine, according to multimedia data in the data to be processed, a second key information describing an event, wherein the multimedia data comprises data obtained by querying based on the query information; and
fuse the first key information and the second key information, so as to obtain an event information of a target event described by the data to be processed.

10. The electronic device according to claim 9, wherein the instructions are further configured to cause the at least one processor to:
determine a subject matter category of the target event and an action category of the target event according to the first key information and the second key information;
determine, according to the subject matter category and the action category, at least one argument role matched with the target event in a predetermined event graph; and
determine, according to the first key information and the second key information, an argument matched with the at least one argument role,
wherein the predetermined event graph indicates a mapping relationship between the subject matter category of the event, the action category of the event, and the argument role matched with the event.

11. The electronic device according to claim 9, wherein the query information comprises a query text; and
wherein the instructions are further configured to cause the at least one processor to:
perform a category labeling on a word in the query text, so as to obtain a category of each word in the query text;
perform, in response to the query text containing a word of a scene category, Part-Of-Speech tagging and Semantic Role Labeling on a word in the query text, so as to obtain a labeling result; and
determine, according to the labeling result, the first key information describing the event.

12. The electronic device according to claim 9, wherein the multimedia data comprises data in at least two modalities; and
wherein the instructions are further configured to cause the at least one processor to:
identify, for data in each modality of the data in the at least two modalities, the data in each modality by using a data identification method matched with the modality, so as to obtain at least one tag; and
rank each tag obtained by identifying the data in the at least two modalities, so as to obtain a tag sequence as the second key information.

13. The electronic device according to claim 9, wherein the multimedia data comprises a plurality of data; and
wherein the instructions are further configured to cause the at least one processor to:
determine, according to each data in the plurality of data, a set of key information describing the event, so as to obtain a plurality of sets of key information; and
fuse the plurality of sets of key information to obtain the second key information.

14. The electronic device according to claim 9, wherein the instructions are further configured to cause the at least one processor to:
determine, for the obtained event information of a plurality of events, a knowledge graph for each event in the plurality of events, according to the event information of each event in the plurality of events;
determine a similarity between two events in the plurality of events according to two knowledge graphs for the two events in the plurality of events; and
determine two events in the plurality of events having a similarity greater than a similarity threshold as a same event.

15. The electronic device according to claim 14, wherein the instructions are further configured to cause the at least one processor to:
encode, for each event in the two events, the knowledge graph for each event to obtain a first encoded feature;
encode the event information of each event to obtain a second encoded feature;
fuse the first encoded feature and the second encoded feature to obtain an event feature of each event; and
determine a similarity between two event features of the two events, so as obtain the similarity between the two events.

16. The electronic device according to claim 9, wherein the multimedia data is accessed data in a plurality of data obtained by querying based on the query information.

17. A non-transitory computer-readable storage medium having computer instructions therein, the computer instructions configured to cause a computer system to at least:
determine, according to a query information in data to be processed, a first key information describing an event;
determine, according to multimedia data in the data to be processed, a second key information describing an event, wherein the multimedia data comprises data obtained by querying based on the query information; and
fuse the first key information and the second key information, so as to obtain an event information of a target event described by the data to be processed.

18. The non-transitory computer-readable storage medium according to claim 17, wherein the computer instructions are further configured to cause the computer system to:
determine a subject matter category of the target event and an action category of the target event according to the first key information and the second key information;
determine, according to the subject matter category and the action category, at least one argument role matched with the target event in a predetermined event graph; and
determine, according to the first key information and the second key information, an argument matched with the at least one argument role,
wherein the predetermined event graph indicates a mapping relationship between the subject matter category of the event, the action category of the event, and the argument role matched with the event.

19. The non-transitory computer-readable storage medium according to claim 17, wherein the query information comprises a query text; and
wherein the computer instructions are further configured to cause the computer system to:
perform a category labeling on a word in the query text, so as to obtain a category of each word in the query text;
perform, in response to the query text containing a word of a scene category, Part-Of-Speech tagging and Semantic Role Labeling on a word in the query text, so as to obtain a labeling result; and
determine, according to the labeling result, the first key information describing the event.

20. The non-transitory computer-readable storage medium according to claim 17, wherein the multimedia data comprises data in at least two modalities; and
wherein the computer instructions are further configured to cause the computer system to:
identify, for data in each modality of the data in the at least two modalities, the data in each modality by using a data identification method matched with the modality, so as to obtain at least one tag; and
rank each tag obtained by identifying the data in the at least two modalities, so as to obtain a tag sequence as the second key information.
